(19) United States
(12) Patent Application Publication
(10) Pub. No.: US 2020/0145306 A1
(43) Pub. Date: May 7, 2020

(54) APPARATUS AND METHOD FOR EVALUATING PACKET TRANSIT TIME AND PACKET DELAY VARIATION

(71) Applicant: Cpacket Networks Inc., San Jose, CA (US)

(72) Inventors: Ron Nevo, Portland, OR (US); Douglas Cooper, Lake Oswego, OR (US)

(21) Appl. No.: 16/183,428

(22) Filed: Nov. 7, 2018

(51) Int. Cl. H04L 12/26

(52) U.S. Cl. CPC H04L 43/067; H04L 43/045; H04L 43/0858; H04L 43/12

(57) ABSTRACT

A system has a monitoring point to collect timing information characterizing transit time over a network for a packet from a first network connected device to a second network connected device. The timing information for packets is aggregated into a time segment. Packet performance measures for the time segment are generated. The packet performance measures are transmitted over the network to a management station.

### FIELD OF THE INVENTION

This invention relates generally to communications in computer networks. More particularly, this invention is directed toward evaluating packet time and packet delay variation in computer networks.

### BACKGROUND OF THE INVENTION

Networks continue to grow in size and line speed. This results in challenging network administration tasks since the volume of information to be analyzed is overwhelming.

There is a need for improved network monitoring techniques, including evaluating packet transit time and packet delay variation.

### SUMMARY OF THE INVENTION

A system has a monitoring point to collect timing information characterizing transit time over a network for a packet from a first network connected device to a second network connected device. The timing information for packets is aggregated into a time segment. Packet performance measures for the time segment are generated. The packet performance measures are transmitted over the network to a management station.

### BRIEF DESCRIPTION OF THE FIGURES

The invention is more fully appreciated in connection with the following detailed description taken in conjunction with the accompanying drawings, in which:

FIG. 1 illustrates a network utilized in accordance with an embodiment of the invention.

FIG. 2 illustrates a system configured in accordance with an embodiment of the invention.

FIG. 3 illustrates a management station configured in accordance with an embodiment of the invention.

FIG. 4 illustrates a forensic network device utilized in accordance with an embodiment of the invention.

Like reference numerals refer to corresponding parts throughout the several views of the drawings.

### DETAILED DESCRIPTION OF THE INVENTION

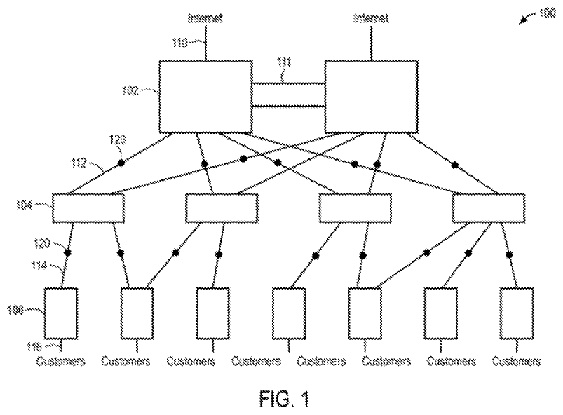

FIG. 1 illustrates an example of a network 100 with representative locations 120 at which a network device can be connected, in accordance with an embodiment of the invention. The network 100 is an example of a network that may be deployed in a data center to connect customers to the Internet. The connections shown in FIG. 1 are bidirectional unless otherwise stated. In one embodiment, the network 100 includes core switches 102, edge routers 104, and access switches 106. The core switches 102 provide connectivity to the Internet through multiple high-capacity links 110, such as 10-Gigabit Ethernet, 10 GEC 802.1Q, and/or OC-192 Packet over SONET links. The core switches 102 may be connected to each other through multiple high-capacity links 111, such as for supporting high availability. The core switches 102 may also be connected to the edge routers 104 through multiple links 112. The edge routers 104 may be connected to the access switches 106 through multiple links 114. The links 112 and the links 114 may be high-capacity links or may be lower-capacity links, such as 1 Gigabit Ethernet and/or OC-48 Packet over SONET links. Customers may be connected to the access switches 106 through physical and/or logical ports 116.

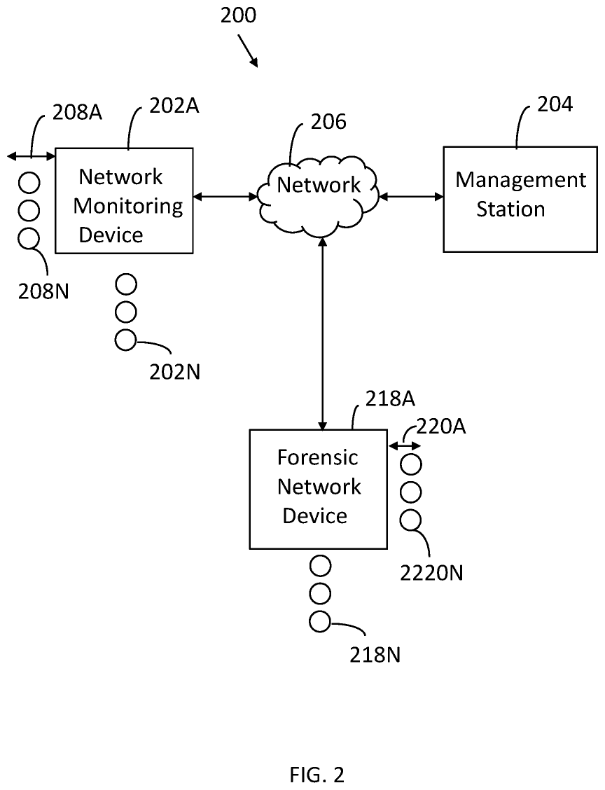

FIG. 2 illustrates a system 200 for evaluating packet transit time and packet delay variation, in accordance with an embodiment of the invention. The system 200 includes network monitoring devices 202A-202N that monitor and perform analyses, such as of network traffic. The network traffic that is monitored and analyzed by the network monitoring devices 202 may enter the network monitoring devices 202 through interfaces 208A-208N. After monitoring and analysis by the network monitoring devices 202, the network traffic may exit the devices through the interfaces if the interfaces are bidirectional, or through other interfaces (not shown) if the interfaces are unidirectional. Each of the devices 202 may have a large number of high-capacity interfaces 208, such as 32 10-Gigabit network interfaces.

In one embodiment, each of the network monitoring devices 202 may monitor and analyze traffic in a corresponding network 100, such as a data center network. Referring to FIG. 1, in one example the interfaces 208 may be connected to the network 100 at corresponding ones of the locations 120. Each of the interfaces 208 may monitor traffic from a link of the network 100. For example, in FIG. 1, one or more network monitoring devices 202 may monitor traffic on the links 112 and 114.

The network monitoring devices 202 are connected to a management station 204 across a network 206. The network 206 may be a wide area network, a local area network, or a combination of wide area and/or local area networks. For example, the network 206 may represent a network that spans a large geographic area. The management station 204 may monitor, collect, and display traffic analysis data from the network devices 202, and may provide control commands to the network devices 202. In this way, the management station may enable an operator, from a single location, to monitor and control network monitoring devices 202 deployed worldwide.

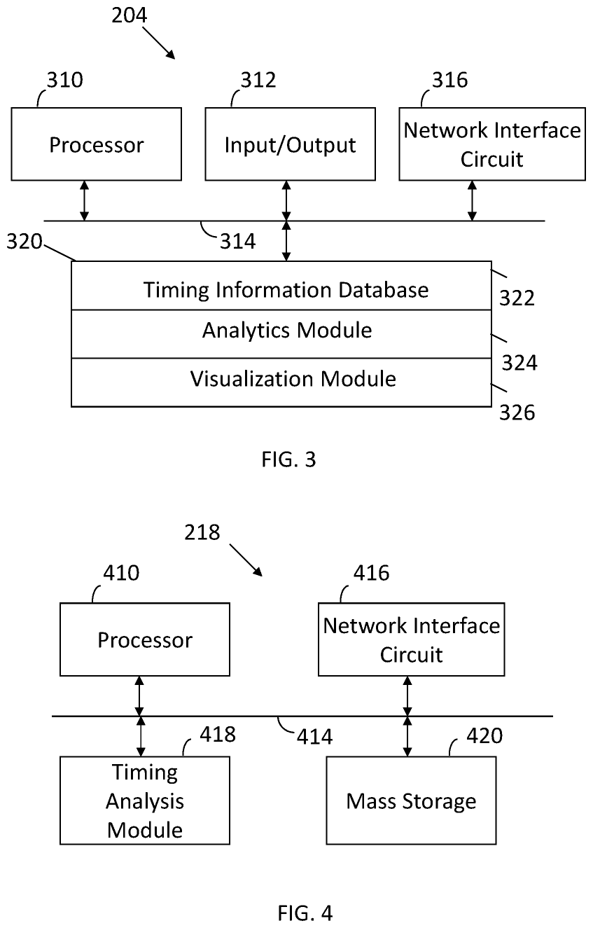

The components discussed up to this point are disclosed in U.S. Pat. No. 9,407,518 (the '518 patent), which is owned by the current applicant. The '518 patent is incorporated herein by reference. The current application builds upon this architecture by utilizing a management station 204 with new features disclosed in connection with the discussion of FIG. 3

The current application also builds upon the prior art architecture of the '518 patent by utilizing one or more forensic network devices 218A-218N. Each forensic network device 218 includes interfaces 220A-220N, which may be of the type discussed in connection with network device 202. The forensic network device 218 is more fully characterized in connection with the discussion of FIG. 4.

FIG. 3 illustrates a management station 204 configured in accordance with an embodiment of the invention. The management station 204 may include a processor 310 connected to input/output devices 312 via a bus 314. The input/output devices 312 may include a keyboard, mouse, touch display and the like. A network interface circuit 316 is also connected to the bus. The network interface circuit 316 provides connectivity to network 206. A memory 320 is also connected to the bus 314. The memory 320 stores data and instructions executed by processor 310. In particular, the memory 320 stores a timing information database 322, details of which are characterized below. The memory 320 also stores an analytics module 324. The analytics module 324 includes instructions executed by the processor 310 to provide packet timing data as detailed below. A visualization module 326 is also stored in memory 320. The visualization module 326 includes instructions executed by the processor 310 to provide packet timing visualizations.

As discussed in the '518 patent, each network monitoring device 202 provides real-time high resolution (i.e., nanoseconds resolution) deep packet inspection data for every bit in every packet at line speed. Each device 202 generates packet level Key Performance Indicators (KPIs) which are continuously fed into the timing information database 322.

FIG. 4 illustrates a forensic network device 218 utilized in accordance with an embodiment of the invention. The device 218 includes a processor connected to a network interface circuit 416 via a bus 414. The network interface circuit 416 provides connectivity to network 206. Mass persistent storage 420 (e.g., a disc array) is also connected to the bus 414. Random access memory 418 stores a timing analysis module with instructions executed by processor 410. The memory 420 stores packets at line rate. The timing analysis module 418 includes instructions executed by the processor to perform port forwarding, aggregation, replication, balancing and filtering. The timing analysis module 418 also produces packet transit time and packet delay variation information, which is incorporated into the timing information database 322. The timing analysis module 418 supports retrospective analysis of network operational issues and security incidents.

Changes in packet delays represent changes in the time packets spend in buffers inside switches and routers along a network path. Increase in buffering is related to microbursts within the network, increased latency and eventually packet drops. As the number and length of microbursts increase, network performance decreases. Therefore, monitoring the latency and changes in latency of a stream of packets along a fixed path provides important insight about the network performance. Observing the latency over time can also help predict the future behavior of the network and help with planning ahead.

There are several methods for representing packet jitter. For example, packet jitter may be represented by the variation of the packet inter-arrival times. The packet jitter may also be represented by the variation in the packet delays. Applicant believes that the packet delay variation gives better insight into the time packets spend inside switches' and routers' buffers along the network path. Therefore, packet delay variation (PDV) is used to represent jitter.

Packet latency statistics are also useful. Trends in the minimum, average and maximum packet latency help identify the onset of congestion in the network. These trends may also provide capacity and performance management insights.

The disclosed technology uses Monitoring Points to independently compute the PDV and Packet Transit Time (latency) statistics for packets traveling between the source Monitoring Point and the receiving Monitoring Point. Each Monitoring Port is a combination of a network monitoring device 202 and a forensic network device 218. These two devices may distribute the computation tasks in any number of ways. By way of example, the network monitoring device 202 is operated to apply a packet arrival time stamp to a packet and information identifying itself and a port that receives the packet. In the disclosed embodiment, the forensic network device 218 aggregates timing information, generates packet performance measures and transmits the packet performance measures over the network to the management station 204. The packet performance measures are a form of condensed information that is made available to the management station 204. Meanwhile, the forensic network device 218 stores all processed packets and therefore can be used by the management station 204 to evaluate the performance of any given packet that traverses the network.

The computation by a Monitoring Point is distributed and is done regardless of the path the packet passes through. This keeps the calculations at each Monitoring Point the same regardless of how many data centers and routers the packets have passed through to get to the Monitoring Point. This distributed method is robust and scalable. The calculations are grouped per stream, i.e. per multicast destination.

In one embodiment, in each time segment of one second, the data is stored and the calculations are restarted. Therefore, the statistics and PDV value only apply to the packets arriving during a single second. Each forensic network device 218 collects the PDV and the latency statistics and stores the data for display and long term storage.

The per second latency statistics give insight into trends, but do not provide enough information to prove how much time a specific packet spent traversing between two points in the network. However this data is only required when debugging and analyzing specific incidents. Hence each forensic network device 218 has the detailed latency information for every packet in the monitored data streams (in mass persistent storage 420) and allows the operator to further analyze them if needed. With this latency data, one can calculate the time any packet takes to travel between two monitored points in the network.

The packet specific transit times at a monitoring point are available on demand via an API. To get the transit times for a range of packets at a number of monitoring points along the network path, the packet transit times are downloaded from each Monitoring Point along this network path. With this information, users at the management station 204 can produce a detailed report of how long specific packets spent traversing different segments of the network.

The solution is designed to be robust, scalable i.e. cost-effective, minimize the amount of data that has to be sent and collected and the computing power required.

### Definitions

Market-data stream is the three tuple: source IPv4 address, destination IPv4 address, destination port.

Monitoring Point is a specific port on a network monitoring device. The calculation can be done at the network monitoring device port or using a forensic network device 218 based on the accurate port time-stamping trailer.

Monitoring Point 0 is the first Monitoring Point, it has to be as close as possible to Market Data server with minimal network latency. Monitoring Point 0 provides indication to the accuracy of the rest of the measurements.

### Assumptions

The accuracy and usefulness of the calculated delay metrics relies upon the following assumptions:

### Network Assumptions

Clock drift and clock offset may be ignored over the measurement intervals of interest (seconds).

The accuracy of the received time (generated time stamp) is better than 1 microsecond; i.e. the network monitoring devices 202 use high accuracy PPS or PTP signals.

The same clock is used for all packets in the same market data stream.

The “first” monitoring point, the point closest to the market data server provides an estimate of the application dwell time.

The route doesn't change during the measurement interval (seconds).

On a given day, the Sequence Number (in the XDP header) may be used to identify packets from each data stream.

### Operational Expectations

Each Monitoring Point is able to mark all data streams and every packet going through it. Calculation might be limited to a few market-data streams, based on the number of network monitoring devices 202 assigned to each forensic network device 218.

Each Monitoring Point calculates the packet transit time for all packets in each monitored market data stream.

Each Monitoring Point calculates the packet delay variation from all packets in each monitored market data stream.

The (multicast) packets from a specific market data server (based upon source IPv4 address) with a given destination (IPv4 address and port) are monitored. The Send Time in the XDP header is used by the Monitoring Point as the source send time for each packet. For each packet, the arrival time is set to the network monitoring device time stamp attached to the packet. Based upon these time stamps, the Monitoring Point calculates the per packet transit time, the per second packet delay variation and the per second latency statistics: minimum, average, maximum and standard deviation.

Monitored traffic arriving at a port of a network monitoring device 202 is sent to a forensic network device 218. Each port of a network monitoring device 202 adds a time stamp to the incoming packets. This is the Arrival Time used by the forensic network device 218. When the forensic network device 218 receives this packet, if it is part of a monitored stream, the device 218 calculates the Packet Transit Time for this packet. The Packet Transit Time is the Arrival Time (from the network monitoring device time stamp) minus the Send Time (from the XDP Header). These individual packet times are stored on the forensic network device 218. Summary statistics of these individual packets times are calculated each second and are collected by the management station 204.

Calculating the Latency Metrics relies upon the following assumptions:

The Monitoring Point has the source IPv4 address, the destination IPv4 address and the destination port for each data stream to be monitored

The Monitoring Point receives market data XDP protocol packets

The Monitoring Point monitors XDP packets with delivery flag 11 (in the XDP header)

The Monitoring Point collects and stores 34 bytes of information from each packet that arrives in a monitored data stream. This list describes in detail what data the forensic network device 218 retains.

10 Bytes to represent the Market Data Stream.

4 Bytes to represent the Source (4 bytes for the source IP Address).

4 Bytes to represent the Destination (4 bytes for the destination IP Address).

2 Bytes to represent the Destination Port.

The above assumes IPv4 addresses.

8 Bytes for the Send Time from the XDP Header.

8 Bytes for the Transit Time (Receive Time from the network monitoring device Time Stamp minus the Send Time from the XDP Header).

4 Bytes for the Sequence Number from the XDP Header.

1 Byte for the Number of Messages in the XDP Packet from the XDP Header.

3 Bytes to represent the cVu port (2 Bytes for the network monitoring device device ID and 1 Byte for the network monitoring device port number).

This assumes the network monitoring device ID is unique.

### Packet Transit Time

Each second, the Monitoring Point processes packets from a number of pre-selected market data streams. The Monitoring Point calculates the time each packet took to arrive. This is the Packet Transit Time. This transit time is the difference between the arrival time at a Monitoring Point minus the Send Time in the XDP Header. From these transit times, the Monitoring Point calculates the minimum, the average, and the maximum transit times, along with the standard deviation of the transit times. These statistics are sent to the management station 204 to be stored.

### Calculating the Packet Transit Time

Each second the Monitoring Point calculates the difference between the network monitoring device time stamp (applied at the ingress of the network monitoring device port) and the Send Time in the XDP Header for every packet sent by a monitored market data stream. This Packet Transit Time is calculated at each Monitoring Point along a network path. This calculation is exactly the same at each Monitoring Point, regardless of how many hops the packet has taken through the network.

The per second summary statistics of the Packet Transit Times include the minimum, average and maximum Packet Transit Time during the second. In addition, the Monitoring Point calculates the standard deviation of the Packet Transit Times along with the number of packets and the range of sequence numbers received during the second. This information is sent to the management station 204 for storage and visualization.

Currently per second summary statistics are calculated based upon arrival time. Ideally, the summary statistics are based upon the packet Send Time. The calculations can be performed on a group of packets all sent within the same second.

Once per second, each Monitoring Point calculates per second statistics of the packet transit times from each monitored data stream. The calculation is based on all the packets that belong to that stream during that second.

If a packet transit time threshold is provided, the monitoring point also counts the number of packets that exceed the given threshold. The output is sent to the management station 204 for display.

The management station 204 collects the following information from each Monitoring Point:

Per second Min, Avg and Max Transit Time

Standard Deviation of the Transit Times during each second

Number of market data packets received during the second

Min sequence number and Max Sequence number

Number of packets with Transit Time (or Delay Variation) exceeding a Threshold Value

### Calculating the Packet Delay Variation

Each second, the Monitoring Point processes all packets from a number of pre-determined market data streams. The Monitoring Point calculates the range of times packets take to arrive. This time range represents the packet delay variation: max(transit time)−min(transit time). The maximum may be replaced with a large percentile, such as 99.9^{th} percentile, if desired.

The packet delay variation during a second will be calculated at each Monitoring Point along a network path. The packet delay variation at each monitoring point is a combination of the delays along the network path between the source and the receiving monitoring points. However, this calculation is exactly the same at each Monitoring Point, regardless of how many segments of the network path the packet has traversed. The management station 204 collects this per second packet delay variation for storage and visualization.

### On Demand Time Metrics for Specific Packets

The packet transit time summary statistics give insight into trends and issues. These statistics do not provide data to identify how much time a specific packet spent traversing between two points in the network. As this data isn't usually required each Monitoring Point saves the latency information about every packet but the management station 204 does not collect and store it. With this information stored at the forensic network device 218, one can calculate the time for any specific packet takes to travel between two monitored points in the network.

If the user identifies a time range, or packets she wishes to explore in details, the Monitoring Point (through the forensic network device 218) provides an API to retrieve the per packet transit times. The monitored multicast data streams are identified by the source IPv4 address, the destination IPv4 address and the destination port. The individual packets within a monitored market data stream may be identified by the Sequence Number (potentially the Send Time in the XDP Packet Header).

If a packet enters the network at Monitoring Point 0 and leaves the network at monitoring point 1, then the time the packet spends inside the network will be the transit time at monitoring point 1 minus the transit time at monitoring point 0. The rest of the transit time at monitoring point 1 must be due to the time the packet spends traveling from the market data server to the network at monitoring point 0.

Timing information for packets with a range of sequence numbers may be downloaded from each forensic network device 218 along the path the packets traveled through the network. These time series may be stored in the timing information database 322 and then be displayed. The visualization module 326 can display the difference between two time series. This allows users to generate and visualize the transit times of specific packets between any two points in the network.

The raw per packet transit times and the summary statistics of the packet transit times are stored in the timing information database 322 as a “market_data_latency” segment of the database. In one embodiment, the data resides in two different measurements inside this database: “perpacket” and “persecond”. This provides the option of applying different retention policies to the different types of data—the raw per packet data and the per second summary data.

### Summary Latency Statistics

Measurement “Persecond”

The summary information calculated each second at the Monitoring Point is pushed to the management station 204. This data is stored in the “persecond” measurement in the timing information database 322 segment named “market_data_latency”. The following is a description of the format of the stored per second summary data.

Tags

The Source IPv4 Address, Destination IPv4 Address and Destination Port identify the source of the multicast stream. The network monitoring device ID (cVu Device ID) and network monitoring device port (cVu port) identify the cVu port receiving the multicast data stream.

| Tag Key | Possible Tag Values | Tag Description |
|---|---|---|
| stream_id | Any valid XDP Feed | Identifies the source |
| | (source IPv4 address, | of the multicast data |
| | destination IPv4 ad- | stream |
| | dress, destination port) | |
| cVu_device_id | Any valid cVu device | The device ID for |
| | ID | the cVu receiving the |
| | | multicast data stream |
| cVu_device_name | Any valid cVu device | String representing |
| | Name | the name of the cVu |
| | | device |
| cVu_port | Any valid port number | The cVu port number |
| | for the cVu device | for the cVu port re- |
| | | ceiving the multicast |
| | | data stream |
| cVu_port_name | Any valid port name | String representing the |
| | for the cVu port | name of the cVu port |
| monitoring_point_name | Any valid name | String representing the |
| | | name of the monitor- |
| | | ing point |

Fields

For the per second aggregations, the statistical aggregations of the transit times (latency) are based upon the difference between the network monitoring device receive time and the XDP header time stamp. The minimum, average, maximum transit times, the number of packets received during the second are stored, along with the minimum and maximum sequence number found in the packets. The number of sequence number gaps and the number of packets exceeding a given threshold latency may also be stored.

| Field Names | Field Value Description |
|---|---|
| latency_min | The minimum latency (transit time) |
| | measurement during the second |
| latency_average | The average latency (transit time) |
| | measurement during the second |
| latency_max | The maximum latency (transit time) |
| | measurement during the second |
| latency_std | The standard deviation of the latency |
| | measurements during the second |
| latency_delay_variation | The packet delay variation of the |
| | latency measurements during the second |
| packet_id_min | The minimum sequence number of the |
| | packets processed this second-typically, |
| | the sequence number of the first packet |
| | to arrive this second |
| packet_id_max | The maximum sequence number of the |
| | packets processed this second-typically, |
| | the sequence number of the last packet |
| | to arrive this second |
| packet_count | The number of packets arriving during |
| | the second |
| latency_count_gt_threshold | The number of packets with latency |
| | exceeding a specified threshold value |

Each summary time series uses the network monitoring device Receive Time as the time index for the time series. In one embodiment, the transit time statistics of the packets are visualized on the vertical “latency” axis, while the second during which these packets arrived at the network monitoring device are on the horizontal “time” axis. If the maximum transit time from monitoring point 0 to monitoring point 1 is much less than a second, then plotting these time series on the same graph still gives insight into what is happening in the network, in spite of the fact that the data points are not calculated from exactly the same group of packets.

To get the maximum latency (each second) for traffic arriving at monitoring point “mp1” from 159.125.70.12 with destination 233.125.89.126:17543 during the first 10 minutes of “2018-10-01”, use the query SELECT “latency_max” FROM “persecond” WHERE “monitoring_point_name”=‘mp1’ AND “stream_id”=‘159.125.70.12_233.125.89.126:17543’ AND ‘2018-10-01T00:00:00Z’<=time AND time <‘2018-10-01T00:10:00Z’ GROUP BY *

### Individual Packet Times

The management station 204 has an API to request the individual packet transit times “on demand”. Given the potential number of packets received per second, requests for per packet transit times occur infrequently and generally cover small ranges of time. When a user requests this per packet latency data, it is brought into the “market_data_latency” database under the “perpacket” measurement. This per packet data includes the Send Time and the Packet Transit Time for each individual packet received at a Monitoring Point.

Tags identify the time series under consideration. Fields are the recorded values associated with the Send Time from the XDP Header.

### Measurement “Perpacket”

The individual packet transit times are calculated and stored at the management station 204. Upon request, this data is downloaded or pushed to the management station 204. To calculate the time a specific range of packets take to travel between monitoring point 0 and monitoring point 1, the user requests the data for these packets from each forensic network device. This data is brought into the “perpacket” measurement of the database segment “market_data_latency”. The transit time at monitoring point 0 is subtracted from the transit time at monitoring point 1 to get the time each packet took to travel between these two points in the network. Below is the format of the stored per packet transit time data.

### Tags

The Source IPv4 Address, Destination IPv4 Address and Destination Port are used to identify the multicast data stream.

The cVu device ID and cVu port identify the cVu port receiving the multicast data stream. As previously indicated, cVu corresponds to a network monitoring device 202.

| Tag Key | Possible Tag Values | Tag Description |
|---|---|---|
| stream_id | Any valid XDP Feed | Identifies the multicast |
| | (source IPv4 address, | market data stream |
| | destination IPv4 address, | |
| | destination port) | |
| cVu_device_id | Any valid cVu device ID | The device ID for the |
| | | cVu receiving the same |
| | | multicast data stream |
| cVu_device_name | Any valid name for the | String representing the |
| | cVu device | name of the cVu device |
| cVu_port | Any valid port number | The cVu port of the |
| | for the cVu device | cVu along the path of |
| | | multicast data stream |
| cVu_port_name | Any valid name for the | String representing the |
| | cVu port | name of the cVu port |

### Fields

For the raw packets, the management station 204 captures the XDP Send Time, the Transit Time (cVu Receive Time−XDP Send Time), the sequence number and the number of messages.

| Field Names | Field Value Description |
|---|---|
| <monitoring point | The time the packet arrived at the cPacket |
| name> | Monitoring Point port minus the XDP Send Time |
| packet_id | The sequence number found in the XDP Header |
| packet_id_increment | The number of messages in the XDP packet (i.e., |
| | the expected difference between the current |
| | packet ID and the next packet ID) |

The time index (horizontal axis of the time series) is the XDP Send Time. The packet transit time is the vertical index.

These time series represent the time packets take to travel from the source to the receiving Monitoring Point. The visualization module 326 may be used to display these time series.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A system, comprising:
a monitoring point to
collect timing information characterizing transit time over a network for a packet from a first network connected device to a second network connected device;
aggregate the timing information for a plurality of packets into a time segment;
generate packet performance measures for the time segment; and
transmit the packet performance measures over the network to a management station.

2. The system of claim 1 wherein the monitoring point comprises a network monitoring device to append to each packet a packet arrival time stamp, a network monitoring device identification and a network monitoring device port identification.

3. The system of claim 2 wherein the monitoring point further comprises a forensic network device connected to the network monitoring device via the network, the forensic network device configured to generate the packet performance measures.

4. The system of claim 3 wherein the packet performance measures include a minimum packet latency transit time measure during the time segment.

5. The system of claim 3 wherein the packet performance measures include an average packet latency transit time measure for the plurality of packets during the time segment.

6. The system of claim 3 wherein the packet performance measures include a maximum packet latency transit time measure during the time segment.

7. The system of claim 3 wherein the packet performance measures include a standard deviation of packet latency measurements during the time segment.

8. The system of claim 3 wherein the packet performance measures include a packet delay variation of packet latency measurements during the time segment.

9. The system of claim 3 wherein the packet performance measures include a minimum packet sequence number observed during the time segment.

10. The system of claim 3 wherein the packet performance measures include a maximum packet sequence number observed during the time segment.

11. The system of claim 3 wherein the packet performance measures include a number of packets observed during the time segment.

12. The system of claim 3 wherein the packet performance measures include a number of packets with latency exceeding a specified threshold.

13. The system of claim 3 wherein the forensic network device stores the plurality of packets processed during the time segment and packets processed during subsequent time segments.

14. The system of claim 13 wherein the management station communicates with the forensic network device via the network to obtain timing information for an individual packet.

15. The system of claim 1 wherein the management station supplies visualizations of packet performance measures.
